(19) United States
(12) Patent Application Publication
(10) Pub. No.: US 2026/0257190 A1
(43) Pub. Date: Sep. 3, 2026

(54) PRESSURE RESISTANT LIGHT ENGINE

(71) Applicant: SIGNIFY HOLDING B.V., EINDHOVEN (NL)

(72) Inventors: NORBERTUS ANTONIUS MARIA SWEEGERS, LIEROP (NL); REMY CYRILLE BROERSMA, EINDHOVEN (NL)

(21) Appl. No.: 18/878,690

(22) PCT Filed: Jun. 26, 2023
(86) PCT No.: PCT/EP2023/067287

§ 371 Date: Dec. 24, 2024

(30) Foreign Application Priority Data
Jul. 1, 2022 (EP) 22182489.9

(51) Int. Cl. B01J 19/12; B01J 19/00; B01J 19/18

(52) U.S. Cl. CPC B01J 19/123; B01J 19/0006; B01J 19/127; B01J 19/128; B01J 19/18; B01J 2219/00162; B01J 2219/0801; B01J 2219/0875; B01J 2219/0877

(57) ABSTRACT

The invention provides a photoreactor assembly (1000) comprising (i) a light source arrangement (700), (ii) a photochemical reactor (200), and (iii) a reaction chamber pressure compensating system (1300); wherein:—the light source arrangement (700) comprises a light chamber (710) hosting a plurality of light sources (10), wherein the light sources (10) are configured to generate light source radiation (11) selected from one or more of UV radiation, visible radiation, and IR radiation; wherein the light chamber (710) has a light chamber pressure P_{L};—the photochemical reactor (200) comprises a reactor chamber (210) configured to host a first fluid (5) to be treated with the light source radiation (11); wherein the photochemical reactor (200) comprises a light transmissive window (211) that is transmissive for the light source radiation (11); wherein the light transmissive window (211) separates the light chamber (710) from the reactor chamber (210); wherein the plurality of light sources (10) are configured to irradiate at least part of the reactor chamber (210) via the light transmissive window (211);—wherein the photochemical reactor (200) comprises a spinning disk reactor (201), wherein the spinning disk reactor (201) comprises a disk (250) at least partly configured in the reaction chamber (210); and—the reaction chamber pressure compensating system (1300) is configured to compensate for a reactor chamber pressure PR in the photochemical reactor (200) on the light transmissive window (211).

### FIELD OF THE INVENTION

The invention relates to a photoreactor assembly comprising a light source arrangement and a photochemical reactor. The invention further relates to a method for treating a fluid with light source radiation from a photoreactor assembly.

### BACKGROUND OF THE INVENTION

Photocatalytic reactors are known in the art. For instance, US2016304368A1 describes an active photocatalytic reactor configured to process biological culturing water with an accelerated process. Water to be used in a biological culturing system is stabilized with pollutants in the water reduced. The active photocatalytic reactor is less affected by outside environment while having faster activating speed. The active photocatalytic reactor can further be combined with a traditional filter to form a serial or parallel connection for more effectively purifying the culturing water with damage to the whole system avoided.

### SUMMARY OF THE INVENTION

Photochemical processing or photochemistry relates to the chemical effect of light. More in general photochemistry refers to a (chemical) reaction caused by absorption of light, especially ultraviolet light (radiation), visible light (radiation) and/or infrared radiation (light). Photochemistry may for instance be used to synthesize specific products. For instance, isomerization reactions or radical reactions may be initiated by light. Other naturally occurring processes that are induced by light are e.g. photosynthesis, or the formation of vitamin D with sunlight. Photochemistry may further e.g. be used to degrade/oxidize pollutants in water or e.g. air. Photochemical reactions may be carried out in a photochemical reactor or “photoreactor”.

One of the benefits of photochemistry is that reactions can be performed at lower temperatures than conventional thermal chemistry and partly for that reason thermal side reactions that generate unwanted by-products are avoided.

Furthermore, commonly used light sources in photochemistry may include low or medium pressure mercury lamps or fluorescent lamps. In addition to that, some reactions may require a very specific wavelength region, and they may even be hampered by light from the source emitted at other wavelengths. In these cases, part of the spectrum may have to be filtered out, which may lead to a low efficiency and complex reactor design.

In the recent years the output of Light Emitting Diodes (LEDs), both direct LEDs with dominant wavelengths ranging for instance from UVC to IR wavelengths, and phosphor-converted LEDs, has increased drastically, making them interesting candidates for light sources for photochemistry. High fluxes can be obtained from small surfaces, especially if the LEDs can be kept at a low temperature.

Spinning disk reactors are a type of chemical reactor used because the small area between a fast rotating disc and the reactor wall may result in very high mixing performance. High gaseous or liquid pressures occur for chemical processes in such spinning disk reactors. The high mixing performance and high pressure may result in a high efficiency of the chemical reaction. However, for photochemical reactors, a spinning disk reactor appears not to be commercially available yet, as the high pressures can cause breaking of the transparent window separating the light sources from the reactor chamber. In the chemical and pharmaceutical industry such an explosive environment with organic substances is highly unwanted due to safety concerns.

Hence, it is an aspect of the invention to provide an alternative photoreactor assembly, which preferably further at least partly obviates one or more of above-described drawbacks. The present invention may have as object to overcome or ameliorate at least one of the disadvantages of the prior art, or to provide a useful alternative.

According to a first aspect, the invention provides a photoreactor assembly (also: “reactor assembly” or “assembly”) which may comprise a light source arrangement, a photochemical reactor, and a reaction chamber pressure compensating system (or: “pressure compensation system”). In embodiments, the light source arrangement may comprise a light chamber hosting a plurality of light sources. Especially, the light sources may be configured to generate light source radiation (or: “light source light”) selected from one or more of UV radiation, visible radiation, and IR radiation. Moreover, the light chamber may have-during operation-a light chamber pressure PL. In embodiments, the photochemical reactor may comprise a reactor chamber configured to host a first fluid (also: “reactor fluid” or “reactor chamber fluid”) to be treated with the light source radiation. Further, the photochemical reactor may comprise a light transmissive window that is transmissive for the light source radiation. Moreover, the light transmissive window may separate the light chamber from the reactor chamber. Especially, the plurality of light sources may be configured to irradiate at least part of the reactor chamber via the light transmissive window. In specific embodiments, the photochemical reactor may comprise a spinning disk reactor. In such embodiments, the spinning disk reactor may comprise a disk (also: “spinning disk” or “reactor disk” or “rotatable disk”) at least partly configured in the reaction chamber. In embodiments, the reaction chamber pressure compensating system may be configured to compensate for a reaction chamber pressure PR in the reactor chamber on the light transmissive window. Therefore, in embodiments the invention provides a photoreactor assembly comprising (i) a light source arrangement, (ii) a photochemical reactor, and (iii) a reaction chamber pressure compensating system; wherein: the light source arrangement comprises a light chamber hosting a plurality of light sources, wherein the light sources are configured to generate light source radiation selected from one or more of UV radiation, visible radiation, and IR radiation, wherein the light chamber has a light chamber pressure PL; the photochemical reactor comprises a reactor chamber configured to host a first fluid to be treated with the light source radiation, wherein the photochemical reactor comprises a light transmissive window that is transmissive for the light source radiation; the light transmissive window separates the light chamber from the reactor chamber, wherein the plurality of light sources are configured to irradiate at least part of the reactor chamber via the light transmissive window; the photochemical reactor comprises a spinning disk reactor, wherein the spinning disk reactor comprises a disk at least partly configured in the reaction chamber; and the reaction chamber pressure compensating system is configured to compensate for a reaction chamber pressure P_{R} in the reactor chamber on the light transmissive window.

With the present method, a photoreactor assembly may be provided comprising e.g. a spinning disk reactor. Such a photoreactor assembly may be able to treat a fluid in the reactor chamber with the light source radiation with high mixing performance and high pressure due to a treatment of the first fluid in the reaction chamber. The high mixing performance and high pressure may result in a high efficiency process of the chemical reaction. With the use of a reaction chamber pressure compensation system, the high pressure may be compensated, and may thereby remove the risk of breaking of the transmissive wall. Such a reaction chamber pressure compensation system may comprise at least one or more elements for compensating the reaction chamber pressure P_{R}, e.g. a pressure control system, a pressure equalizer, a light chamber fluid, or light chamber support elements. Hence, such photoreactor assembly may provide a high efficiency process of the chemical reaction with minimal safety concerns.

As indicated above, the invention provides a photoreactor assembly. In embodiments, the photoreactor assembly may comprise a light source arrangement, a photochemical reactor, and a reaction chamber pressure compensation system. The light source arrangement may comprise one or more light sources configured in a light chamber to generate light source radiation selected from one or more of UV radiation, visible radiation, and IR radiation. In further embodiments, the light source arrangement may comprise a plurality of light sources configured to generate light source radiation selected from one or more of UV radiation, visible radiation, and IR radiation.

The terms “light” and “radiation” are herein interchangeably used, unless clear from the context that the term “light” only refers to visible light. The terms “light” and “radiation” may thus refer to UV radiation, visible light, and IR radiation. In specific embodiments, especially for lighting applications, the terms “light” and “radiation” refer to visible light.

In embodiments, the light source radiation may comprise UV radiation. The light source radiation may in further embodiments (also) comprise visible radiation. In yet further embodiments, the light source radiation may (also) comprise IR radiation. The term “UV radiation” is known to the person skilled in the art and relates to “ultraviolet radiation”, or “ultraviolet emission”, or “ultraviolet light”, especially having one or more wavelengths in the range of about 10-380 nm. In embodiments, UV radiation may especially have one or more wavelength in the range of about 100-380 nm, such as selected from the range of 190-380 nm. Moreover, the term “UV radiation” and similar terms may also refer to one or more of UVA, UVB, and UVC radiation. UVA radiation may especially refer to having one or more wavelengths in the range of about 315-380 nm. UVB radiation may especially refer to having one or more wavelengths in the range of about 280-315 nm. UVC radiation, may further especially have one or more wavelengths in the range of about 100-280 nm. In embodiments, the light sources may be configured to provide light source radiation having wavelengths larger than about 190 nm. In embodiments, the light source radiation may include wavelengths in the 380-400 nm, which is in the art sometimes indicated as part of the UVA and in other art as part of the visible wavelength range.

The terms “visible”, “visible light”, “visible emission”, or “visible radiation” and similar terms refer to light having one or more wavelengths in the range of about 380-780 nm. The term “IR radiation” especially relates to “infrared radiation”, “infrared emission”, or “infrared light”, especially having one or more wavelengths in the range of 780 nm to 1 mm. Moreover, the term “IR radiation” and similar terms may also refer to one or more of NIR, SWIR, MWIR, LWIR, FIR radiation. NIR may especially relate to Near-infrared radiation having one or more wavelength in the range of about 750-1400 nm, such as 780-1400 nm. SWIR may especially relate to Short-wavelength infrared having one or more wavelength in the range of about 1400-3000 nm. MWIR may especially relate to Mid-wavelength infrared having one or more wavelength in the range of about 3000-8000 nm. LWIR may especially relate to Long-wavelength infrared having one or more wavelength in the range of about 8-15 μm. FIR may especially relate to Far infrared having one or more wavelength in the range of about 15-1000 μm.

In further embodiments, the light source arrangement may at least partly be comprised within a light chamber and may comprise a support arrangement for the one or more light sources. The support arrangement may especially be configured to support the light sources. The term “light source arrangement” may herein refer to the arrangement of one or more light sources, especially a plurality of light sources., i.e., a spatial arrangement (such as relative to the photochemical reactor). The light source support arrangement may itself be supported by a support that comprises the light chamber, which may be referred to as light chamber support.

The light chamber may have a light chamber pressure PL. This may be defined as the pressure exerted on the surfaces (defining a volume of the light chamber) of the light chamber and the contents of the light chamber. In embodiments, the light chamber pressure PL may be at least atmospheric pressure: 1 bar. Further, during operation the light chamber pressure PL may be higher than atmospheric pressure. This may especially be controlled by the pressure control system, and will be further described below.

The term “reactor” may especially relate to a (photo)chemical reactor. The term may essentially relate to an enclosed (reactor) chamber in which a (photochemical) reaction may take place. The (photochemical) reaction may take place due to irradiation of a fluid with the light source radiation.

In further embodiments, the photochemical reactor may comprise a reactor chamber further comprising a flow reactor system. In embodiments, the reactor chamber and the light chamber may be configured in optical contact. Optical contact may refer to the transfer of light (or radiation) between two conformal surfaces, such as between the reactor chamber and light chamber. Hence, in embodiments radiation of the light source(s) may propagate via the light chamber into the flow reactor system (comprised by the reactor chamber). As indicated above, the reactor chamber and the light chamber may comprise light transmissive materials. The light transmissive materials of the reactor chamber and light chamber may be the same or may be different. When the reactor chamber and the light chamber are part of a monolithic body, they will in general comprise essentially the same light transmissive materials. In specific embodiments, only the light chamber comprises light transmissive material. In specific embodiments, (only) the light chamber may be transparent for at least part of the light source radiation. In other embodiments, both the reactor chamber and the light chamber may be transparent for at least part of the light source radiation.

In embodiments, the flow reactor system may comprise a reactor channel, through which the first fluid may be flown. In embodiments, the flow reactor system may be configured to react one or more reactor fluid(s) within flow reactor cells in the reactor channel or comprised by the reactor channel. In further embodiments, the one or more chemicals flown through the flow reactor cells may (also) be reacted with the light source radiation irradiated on the one or more chemicals. The flow reactor system may be configured for hosting the (reactor) fluid to be treated, especially with light source radiation. In embodiments, the flow reactor system may be configured in a radiation receiving relationship with (at least part of) the plurality of light sources. Hence, the first fluid may be transported through the flow reactor system and at least part of the flow reactor system may be irradiated with the radiation.

More especially, the flow reactor system may comprise one or more channels and optionally one or more reaction chamber in fluid contact with the one or more channels. The radiation may be provided to at least part of the one or more channels, or, when one or more reaction chambers are available, alternatively or additionally to the one or more reaction chambers. A reaction chamber may comprise a flow reactor cell. However, the reactor chamber may also be channel, or a part of the channel. Hence, in embodiments the reactor chamber may be channel, having essentially the same cross-sectional dimensions as an upstream channel part and a downstream channel part. However, in other embodiments, such as in the case of a spinning disk reactor, the reactor chamber may have cross-sectional dimensions different from an upstream channel (part) and/or a downstream channel (part).

The reactor fluid may comprise one or more of a liquid and a gas. The term “fluid” may also refer to a combination of two or more different fluids. When the reactor fluid comprises a liquid, the liquid may comprise one liquid or two or more different liquids. The liquid may in embodiments also comprise particulate material. When the reactor fluid comprises a gas, the gas may comprise one type of gas or two or more types of different gasses. The fluid may comprise particulate catalyst material or may comprise a homogenous catalyst, but may in other embodiments also comprise no catalyst. The fluid may comprise an emulsion.

Chemical reactions in reactors are known to the person skilled in the art. Further, the irradiation with radiation may in embodiments lead to a chemical reaction, which may also include a dissociation (see further also below).

In specific embodiments, the photochemical reactor may comprise a spinning disk reactor. The spinning disk reactor may comprise a rotatable spinning disk. Such spinning disk may consist of two main parts: a wheel part (or: “wheel”) and an axle part (or: “axle”). In embodiments, the wheel part of the spinning disk may be rotatable around a fixed axis defined by the axle part. The axle part may be connected to a further mechanical system. As the mechanical system rotates the axle part it may drive the rotation of the wheel part.

The spinning disk may be at least partly configured in the reaction chamber. In embodiments, at least the wheel part of the spinning disk may be configured entirely in the reaction chamber. Further, the spinning disk comprising the wheel part and axle part may be entirely configured within the reaction chamber. In other embodiments, at least part of the axle part may be configured outside of the reaction chamber. Moreover, the axle part may be configured entirely outside of the reaction chamber.

The rotational speed of the spinning disk may in embodiments be controlled (with a control system; see also below). In embodiments, the spinning disk may be under on-off control, with a single rotational speed being available when the spinning disk is turned on. In other embodiments, the spinning disk may be able to operate at multiple speed settings when the spinning disk is turned on. In further embodiments, the rotational speed of the spinning disk may increase or decrease in gradual advancement when the spinning disk is turned on.

In embodiments, the spinning disk may be turned on for at least part of the duration of the (photo)chemical reaction. Especially, the spinning disk may be turned on for the entire duration of the (photo)chemical reaction. In other embodiments, the spinning disk may be turned on for a specific duration during the (photo)chemical reaction and turned off after that duration. Further, the spinning disk may be turned on and off at least twice or more during the (photo)chemical reaction.

In embodiments, the spinning disk may have at least one or more rotational speeds during the (photo)chemical reaction. In specific embodiments, especially those wherein the spinning disk only has an on-off control, the spinning disk may retain the same rotational speed during the (photo)chemical reaction. In other embodiments, the spinning disk may change rotational speed at least once or more during the (photo)chemical reaction. In such embodiments where the spinning disk is turned on and off multiple times at least twice or more during the (photo)chemical reaction, the spinning disk may have different rotational speeds.

In embodiments, the range of the rotational speed of the spinning disk may be 180°/s-36000°/s, such as 360°/s-36000°/s. The range of the rotational speed may especially be 540°/s-36000°/s, such as 540°/s-27000°/s. In embodiments, the range of the rotational speed may be 720°/s-27000°/s, and may especially be 720°/s-18000°/s. Further, the range of the rotational speed may be 1080°/s-36000°/s, such as 1080°/s-18000°/s.

Moreover, the range of the rotational speed may be 1440°/s-18000°/s, such as 1440°/s 9000°/s.

Further, the reactor chamber pressure P_{R} in the reactor chamber may be controlled. In embodiments, the control system may yet increase the reactor chamber pressure P_{R} resulting in improved efficiency of the (photo)chemical reaction. The reactor chamber pressure P_{R} may be increased by increasing the volume of fluid in the reactor chamber.

Through the rotation of the spinning disk, especially the wheel part of the spinning disk, the spinning disk may exert a force on the reactor chamber and/or the fluid in the reactor chamber. This force may result in (i) mixing the first fluid with high efficiency and (ii) increasing the reactor chamber pressure P_{R}. Mixing the first fluid with high efficiency may result in improved reaction rate and may hence reach equilibrium faster. Increasing the reactor chamber P_{R} may likewise in improved reaction rate and may hence reach equilibrium faster.

In other embodiments, the photochemical reactor may instead comprise a flow reactor. The flow reactor may comprise a reactor channel, through which the first fluid may be flown. In embodiments, the flow reactor may be configured to react one or more rector fluid(s) within flow reactor cells in the reactor channel or comprised by the reactor channel. In further embodiments, the one or more chemicals flown through the flow reactor cells may (also) be reacted with the light source light irradiated on the one or more chemicals. The flow reactor may be configured for hosting the (reactor) fluid to be treated, especially with light source light. In embodiments, the flow reactor system may be configured in a radiation receiving relationship with (at least part of) the plurality of light sources. Hence, a fluid may be transported through the flow reactor system and at least part of the flow reactor system may be irradiated with the radiation.

More especially, the flow reactor may comprise one or more channels and optionally one or more reaction chamber in fluid contact with the one or more channels. The light source light may be provided to at least part of the one or more channels, or, when one or more reaction chambers are available, alternatively or additionally to the one or more reaction chambers. A reaction chamber may comprise a flow reactor cell. The photochemical reactor may comprise a plurality of flow reactor cells. In such embodiments, the flow reactor may essentially comprise a tube shape. In other embodiments, the flow reactor may comprise a flat square shape. The flow reactor may be a flat glass square with reactor channels meandering through it, especially forming a ‘clover-leaf’profile.

In other embodiments, the flow reactor may comprise a plate reactor, wherein a reactor chamber may be defined by two essentially parallel plates, and the fluid may flow between plates. In specific embodiments, the plates may be essentially planar. In other embodiments, the plates may comprise cavities and/or protrusions.

Within the context of a photochemical reactor, the photochemical reaction of the first fluid may be driven by exposure to light generated by the light source. Mixing the first fluid with high efficiency may result in a more even dispersion of the various compounds in the first fluid and hence more even exposure to the light source light, especially in those embodiments wherein the light source light may not penetrate evenly throughout the reactor chamber. Hence the mixing by the spinning disk may result in an improved reaction rate.

In other embodiments, the reaction driven by the photochemical reactor may comprise a multistep reaction. Especially, such a multistep reaction may comprise at least two or more (photo)chemical reactions. In such embodiments, at least one or more of the two or more (photo)chemical reactions may be a photochemical reaction. In embodiments wherein one or more of the (photo)chemical reactions is not a photochemical reaction, the increased pressure in the reactor chamber P_{R} by the spinning disk may improve the reaction rate of the one or more reaction steps that is not a photochemical reaction.

In embodiments, the reactor chamber pressure P_{R} may be at least atmospheric pressure: 1 bar. This may especially be the case when the spinning disk is turned off or when the spinning disk has a low rotational speed, such as 180°/s. Further, the reactor chamber pressure P_{R} may be higher than atmospheric pressure as a result of the rotational speed of the spinning disk.

In specific embodiments, the reactor chamber pressure P_{R} may be at least 1 bar, such as at least 1.5 bar. Further, the reactor chamber pressure P_{R} may be at least 2 bar, such as at least 3 bar. In embodiments, the reactor chamber pressure P_{R} may be at least 4 bar, especially 5 bar. Further, the reactor chamber pressure P_{R} may be at least 7 bar, such as 10 bar. Moreover, the reactor chamber pressure P_{R} may be at least 15 bar, such as 20 bar. However, other values are herein not excluded.

In specific embodiments, the reactor chamber pressure P_{R} may be a maximum of 20 bar, such as a maximum of 15 bar. Further, the reactor chamber pressure P_{R} may be a maximum of 10 bar, such as a maximum of 7 bar. In embodiments, the reactor chamber pressure P_{R} may be a maximum of 5 bar, especially 4 bar. Moreover, the reactor chamber pressure P_{R} may be a maximum of 3 bar. However, other values are herein not excluded. In embodiments, the pressure control system may be configured to control the light chamber pressure P_{L} in the light chamber. Especially, the pressure control system may comprise a control system that may be dedicated to controlling the light chamber pressure P_{L}. As the reactor chamber pressure P_{R} may increase relative to atmospheric pressure, there will also be pressure buildup on the surface of parts of the reactor chamber that face the light chamber.

Especially, there may be pressure buildup on the transmissive window facilitating light source light from the light chamber to reach the reactor chamber. Such increased reactor chamber pressure P_{R} may potentially result in failure, or even breaking, of these materials.

Hence, to prevent such safety concerns, the pressure control system may control the light chamber pressure P_{L} to compensate for the increased reactor chamber pressure P_{R}.

When the pressure control system is controlling the light chamber pressure P_{L}, the light chamber pressure P_{L} may be at least 1 bar, such as at least 1.5 bar. Further, the reactor chamber pressure P_{L} may be at least 2 bar, such as at least 3 bar. In embodiments, the reactor chamber pressure P_{L} may be at least 4 bar, especially 5 bar. Further, the reactor chamber pressure P_{L} may be at least 7 bar, such as 10 bar. Moreover, the reactor chamber pressure P_{L} may be at least 15 bar, such as 20 bar.

The pressure control system may in embodiments only increase the light chamber pressure P_{L} when the reactor chamber pressure P_{R} is increased. In specific embodiments, especially those where the spinning disk has only an on-off control, the pressure control system may compensate for the reactor chamber pressure P_{R} increase when the spinning disk is turned on without any further input. In further embodiments, especially those where the spinning disk may have multiple rotational speeds, the pressure control system may compensate for the reactor chamber pressure P_{R} increase when the spinning disk is turned on, and may compensate accordingly depending on the rotational speed of the spinning disk.

The pressure control system may comprise a control system. The term “controlling” and similar terms especially refer at least to determining the behavior or supervising the running of an element. Hence, herein “controlling” and similar terms may e.g. refer to imposing behavior to the element (determining the behavior or supervising the running of an element), etc., such as e.g. measuring, displaying, actuating, opening, shifting, changing temperature, etc .. Beyond that, the term “controlling” and similar terms may additionally include monitoring. Hence, the term “controlling” and similar terms may include imposing behavior on an element and also imposing behavior on an element and monitoring the element. The controlling of the element can be done with a control system, which may also be indicated as “controller”. The control system and the element may thus at least temporarily, or permanently, functionally be coupled. The element may comprise the control system. In embodiments, the control system and element may not be physically coupled. Control can be done via wired and/or wireless control. The term “control system” may also refer to a plurality of different control systems, which especially are functionally coupled, and of which e.g. one control system may be a master control system and one or more others may be slave control systems. A control system may comprise or may be functionally coupled to a user interface.

The control system may also be configured to receive and execute instructions from a remote control. In embodiments, the control system may be controlled via an App on a device, such as a portable device, like a Smartphone or I-phone, a tablet, etc. The device is thus not necessarily coupled to the lighting system, but may be (temporarily) functionally coupled to the lighting system.

Hence, in embodiments the control system may (also) be configured to be controlled by an App on a remote device. In such embodiments the control system of the lighting system may be a slave control system or control in a slave mode. For instance, the lighting system may be identifiable with a code, especially a unique code for the respective lighting system. The control system of the lighting system may be configured to be controlled by an external control system which has access to the lighting system on the basis of knowledge (input by a user interface of with an optical sensor (e.g. QR code reader) of the (unique) code. The lighting system may also comprise means for communicating with other systems or devices, such as on the basis of Bluetooth, Thread, WIFI, LiFi, ZigBee, BLE or WiMAX, or another wireless technology.

The system, or apparatus, or device may execute an action in a “mode” or “operation mode” or “mode of operation” or “operational mode”. The term “operational mode may also be indicated as “controlling mode”. Likewise, in a method an action or stage, or step may be executed in a “mode” or “operation mode” or “mode of operation” or “operational mode.” This does not exclude that the system, or apparatus, or device may also be adapted for providing another controlling mode, or a plurality of other controlling modes. Likewise, this may not exclude that before executing the mode and/or after executing the mode one or more other modes may be executed.

However, in embodiments a control system may be available, that is adapted to provide at least the controlling mode. Would other modes be available, the choice of such modes may especially be executed via a user interface, though other options, like executing a mode in dependence of a sensor signal or a (time) scheme, may also be possible. The operation mode may in embodiments also refer to a system, or apparatus, or device, that can only operate in a single operation mode (i.e. “on”, without further tunability).

Hence, in embodiments, the control system may control in dependence of one or more of an input signal of a user interface, a sensor signal (of a sensor), and a timer. The term “timer” may refer to a clock and/or a predetermined time scheme.

In other embodiments, the pressure control system may comprise a reactor chamber pressure sensor. The reactor chamber pressure sensor may be at least partly configured in the reactor chamber and may provide the pressure control system with measurements on the reactor chamber pressure P_{R}. Hence, the pressure control system may be able to control the light chamber pressure P_{L} based on the feedback it receives from the reactor chamber pressure sensor. This may allow the pressure control system to finetune the most appropriate light chamber pressure P_{L} for the reactor chamber pressure P_{R}. In specific embodiments, the pressure control system may use a feedforward system wherein early signs of increased pressure difference AP may lead to controlling the light chamber pressure P_{L} to compensate.

In further embodiments, the pressure control system may comprise a light chamber pressure sensor. The light chamber pressure sensor may be at least partly configured in the light chamber and may provide the pressure control system with measurements on the light chamber pressure P_{L}. Hence, the pressure control system may be able to control the light chamber pressure P_{L} based on the feedback it receives from the light chamber pressure sensor. This may allow the pressure control system to finetune the most appropriate light chamber pressure P_{L} for the reactor chamber pressure P_{R}.

In embodiments, the control system may be configured to control one or more of the light source radiation of the plurality of light sources and a rotational speed of the spinning disk. The light source radiation and rotational speed of the spinning disk may hence be optimized for the (photo)chemical reaction to take place by the control system. In embodiments, the light source radiation and rotational speed may be adjusted independently of one another. In other embodiments, the light source radiation and rotational speed may be adjusted dependent on one another, such as to further optimize the (photo)chemical reaction. In embodiments, the (plurality of) light sources may especially comprise solid state light sources. The term “light source” may in principle relate to any light source known in the art. It may be a conventional (tungsten) light bulb, a low pressure mercury lamp, a high pressure mercury lamp, a fluorescent lamp, a LED (light emissive diode). In a specific embodiment, the light source comprises a solid state LED light source (such as a LED or laser diode (or “diode laser”)). The term “light source” may also relate to a plurality of light sources, such as 2-2000 (solid state) LED light sources. Hence, the term LED may also refer to a plurality of LEDs. Further, the term “light source” may in embodiments also refer to a so-called chips-on-board (COB) light source. The term “COB” especially refers to LED chips in the form of a semiconductor chip that is neither encased nor connected but directly mounted onto a substrate, such as a PCB. Hence, a plurality of light emitting semiconductor light source may be configured on the same substrate. In embodiments, a COB is a multi LED chip configured together as a single lighting module.

The light source may have a light escape surface. Referring to conventional light sources such as light bulbs or fluorescent lamps, it may be outer surface of the glass or quartz envelope. For LED's it may for instance be the LED die, or when a resin is applied to the LED die, the outer surface of the resin. In principle, it may also be the terminal end of a fiber. The term escape surface especially relates to that part of the light source, where the light actually leaves or escapes from the light source. The light source is configured to provide a beam of light. This beam of light (thus) escapes from the light exit surface of the light source.

Likewise, a light generating device may comprise a light escape surface, such as an end window. Further, likewise a light generating system may comprise a light escape surface, such as an end window.

The term “light source” may refer to a semiconductor light-emitting device, such as a light emitting diode (LEDs), a resonant cavity light emitting diode (RCLED), a vertical cavity laser diode (VCSELs), an edge emitting laser, etc . . . The term “light source” may also refer to an organic light-emitting diode (OLED), such as a passive-matrix (PMOLED) or an active-matrix (AMOLED). In a specific embodiment, the light source comprises a solid-state light source (such as a LED or laser diode). In an embodiment, the light source comprises a LED (light emitting diode). The terms “light source” or “solid state light source” may also refer to a superluminescent diode (SLED).

The term LED may also refer to a plurality of LEDs.

The term “light source” may also relate to a plurality of (essentially identical (or different)) light sources, such as 2-2000 solid state light sources. In embodiments, the light source may comprise one or more micro-optical elements (array of micro lenses) downstream of a single solid-state light source, such as a LED, or downstream of a plurality of solid-state light sources (i.e. e.g. shared by multiple LEDs). In embodiments, the light source may comprise a LED with on-chip optics. In embodiments, the light source comprises a pixelated single LEDs (with or without optics) (offering in embodiments on-chip beam steering).

In embodiments, the light source may be configured to provide primary radiation, which is used as such, such as e.g. a blue light source, like a blue LED, or a green light source, such as a green LED, and a red light source, such as a red LED. Such LEDs, which may not comprise a luminescent material (“phosphor”) may be indicated as direct color LEDs.

In other embodiments, however, the light source may be configured to provide primary radiation and part of the primary radiation is converted into secondary radiation.

Secondary radiation may be based on conversion by a luminescent material. The secondary radiation may therefore also be indicated as luminescent material radiation. The luminescent material may in embodiments be comprised by the light source, such as a LED with a luminescent material layer or dome comprising luminescent material. Such LEDs may be indicated as phosphor converted LEDs or PC LEDs (phosphor converted LEDs). In other embodiments, the luminescent material may be configured at some distance (“remote”) from the light source, such as a LED with a luminescent material layer not in physical contact with a die of the LED. Hence, in specific embodiments the light source may be a light source that during operation emits at least light at wavelength selected from the range of 380-470 nm. However, other wavelengths may also be possible. This light may partially be used by the luminescent material.

In embodiments, the light generating device may comprise a luminescent material. In embodiments, the light generating device may comprise a PC LED. In other embodiments, the light generating device may comprise a direct LED (i.e. no phosphor). In embodiments, the light generating device may comprise a laser device, like a laser diode. In embodiments, the light generating device may comprise a superluminescent diode. Hence, in specific embodiments, the light source may be selected from the group of laser diodes and superluminescent diodes. In other embodiments, the light source may comprise an LED.

The light source may especially be configured to generate light source light having an optical axis (O), (a beam shape,) and a spectral power distribution. The light source light may in embodiments comprise one or more bands, having band widths as known for lasers.

The term “light source” may (thus) refer to a light generating element as such, like e.g. a solid state light source, or e.g. to a package of the light generating element, such as a solid state light source, and one or more of a luminescent material comprising element and (other) optics, like a lens, a collimator. A light converter element (“converter element” or “converter”) may comprise a luminescent material comprising element. For instance, a solid state light source as such, like a blue LED, is a light source. A combination of a solid state light source (as light generating element) and a light converter element, such as a blue LED and a light converter element, optically coupled to the solid state light source, may also be a light source (but may also be indicated as light generating device). Hence, a white LED is a light source (but may e.g. also be indicated as (white) light generating device).

The term “light source” herein may also refer to a light source comprising a solid state light source, such as an LED or a laser diode or a superluminescent diode.

The “term light source” may (thus) in embodiments also refer to a light source that is (also) based on conversion of light, such as a light source in combination with a luminescent converter material. Hence, the term “light source” may also refer to a combination of a LED with a luminescent material configured to convert at least part of the LED radiation, or to a combination of a (diode) laser with a luminescent material configured to convert at least part of the (diode) laser radiation.

In embodiments, the term “light source” may also refer to a combination of a light source, like a LED, and an optical filter, which may change the spectral power distribution of the light generated by the light source. Especially, the “term light generating device” may be used to address a light source and further (optical components), like an optical filter and/or a beam shaping element, etc.

The phrases “different light sources” or “a plurality of different light sources”, and similar phrases, may in embodiments refer to a plurality of solid-state light sources selected from at least two different bins. Likewise, the phrases “identical light sources” or “a plurality of same light sources”, and similar phrases, may in embodiments refer to a plurality of solid-state light sources selected from the same bin.

The term “solid state light source”, or “solid state material light source”, and similar terms, may especially refer to semiconductor light sources, such as a light emitting diode (LED), a diode laser, or a superluminescent diode.

In embodiments, the control system may be configured to control the light source radiation of the plurality of light sources, for instance in dependence of a sensor signal (see also below). In embodiments, the reaction chamber pressure compensating system may comprise one or more support elements. Hence, in embodiments, the photoreactor assembly may further comprise one or more support elements. Such support elements may in embodiments provide an (additional) measure to compensate for the increased reactor chamber pressure P_{R}. Especially in such embodiments without a reactor chamber pressure sensor, support elements may provide additional support to materials in the light chamber to ensure safe operation of the (photo)chemical reactor. Effectively, the one or more additional supports may provide support to the light transmissive window when the light transmissive window experiences a pressure larger than 1 bar at the reactor chamber side, such as especially when the light transmissive window experiences a pressure larger than 1.2 bar at the reactor chamber side.

The one or more support elements may especially be configured to support the light transmissive window, as the light transmissive window is the material most at risk for failure, or breaking, due to the increase from the reactor chamber pressure P_{R}. In embodiments, the one or more support elements may be configured in physical contact with the light transmissive window. In specific embodiments, the one or more support elements may be partially inserted into the light transmissive window. In other embodiments, the one or more support elements may be placed on top of the surface of the light transmissive window facing the light chamber.

At least one of the support elements may be configured between at least two light sources of the plurality of light sources. Hence, the positioning of the support elements may be optimized to support the light transmissive window without hindering the light source light from reaching the reactor chamber.

In embodiments, the support elements may be configured in an array, especially a 2D array. The array may be regular, random, or quasi random. Especially, in embodiments the array is a regular 2D array. However, other arrays, like a phyllotaxis tessellation or a sunflower tessellation, may also be possible. Especially, the array may be a regular array.

When the support elements are in contact with the light transmissive window, in the range of 5-30%, such as in the range of 5-25%, more especially in the range of 5-20% of a surface area of the light transmissive window (at the light chamber side) may be in contact with the support elements. In this way, there may be enough area of the light transmissive window through which light source radiation may escape into the reaction chamber.

The light transmissive window may comprise a light transmissive material selected from the group of quartz, sapphire, borosilicate glass, sodalime glass, mineral glass, laminated glass, coated glass, etc. The light transmissive material may be selected based on its ability to be transmissive for the light source light. The light transmissive material may be selected based on its ability to withstand the reactor chamber pressure P_{R}. Especially, the light transmissive window material may be selected based on a balance of the two aforementioned reasons. Further, the light transmissive window material may yet be selected based on further factors, such as cost-effectiveness or availability.

As described above, the photoreactor assembly may further comprise a light source support configured to support the (plurality of) light sources. Such light source support may in embodiments be non-transmissive for light source light. Any light source light escaping in the direction of the light source support may hence not escape out of the light chamber. In other embodiments, the light source support may be reflective for light source light. Any light source light escaping in the direction of the light source support may hence be reflected back to the direction of the reactor chamber, which may be more efficient. In embodiments, the light source support may be thermally conductive or electrically conductive. In further embodiments, the light source support may comprise a printed circuit board (or: “PCB”). Especially, the PCB may be a metal core PCB or a ceramic metal core PCB. Especially, the light source support may comprise one or more of a CEM-1 PCE, a CEM-3 PCE, a FR-1 PCE, a FR-2 PCB, a FR-3 PCB, a FR-4 PCB, and aluminum metal core PCB, especially one or more of a CEM-1 PCB, a CEM-3 PCB, a FR-1 PCB, and a FR4 PCB and an aluminum metal core PCB, more especially one or more of a CEM-1 PCB, a CEM-3 PCB, a FR-1 PCB. Especially, the PCB comprises a metal core PCB. Therefore, in embodiments the PCB comprises a thermally conductive material, such as aluminum. PCBs comprising a metal core may also be indicated as insulated metal substrate (IMS).

The PCB may comprise a plurality of layer elements. The term “layer element” may refer to a single layer or to a plurality of layers. Essentially all layers describe herein are comprised by a stack or laminate. Hence, the PCB may comprise a stack (or laminate) of layers. This stack may also be indicated as “PCB stack”. The number of layers and type of layers may vary over the PCB. Basically, in embodiments the PCB may comprise over its entire length and width a (PCB) stack of layers comprising the first layer element and the second layer element.

Herein, the term “contact” or “in contact”, and similar terms, may especially refer in embodiments to physical contact. For instance, the layers or layer elements that are in contact may adhere to each other, as known in the art of e.g. PCBs. Instead of the term “electrical contact”, and similar terms, also the terms “electrical conductive contact” or “electrically conductive contact”, and similar terms, may be used.

Herein, the term “functionally coupled” may in embodiments refer to a physical connection or mechanical connection between at least two elements, such as via one or more of a screw, a solder, an adhesive, a melt connection, a click connection, etc. The terms “physical connection” and “mechanical connection” may herein interchangeably be used. The terms “physical connection” and “mechanical connection” may thus also refer to an adhesive connection. Alternatively or additionally, the term “functionally coupled” may in embodiments refer to an electrical conductive connection between at least two connections. When two (or more) elements have an electrical conductive connection, then there may be a conductivity (at room temperature) between the two (or more) elements of at least 1 10⁵ S/m, such as at least 1·10⁶ S/m. In general, an electrically conductive connection will be between two (or more) elements each comprising an electrically conductive material, which may be in physical contact with each other or between which an electrically conductive material is configured. Herein a conductivity of an insulated material may especially be equal to or smaller than 1·10⁻¹⁰ S/m, especially equal to or smaller than 1·10⁻¹³ S/m. Herein a ratio of an electrical conductivity of an isolating material (insulator) and an electrical conductivity of an electrically conductive material (conductor) may especially be selected smaller than 1·10⁻¹⁵ In specific embodiments, a functional coupling may also comprise a coupling via wireless communication, such a via Wi-Fi or BlueTooth or LiFi, etc.

An electrically conductive element may comprise, or essentially consist of electrically conductive material. An electrically insulating element may comprise, or essentially consist of electrically insulating material. Herein, in embodiments a conductive material may especially comprise a conductivity (at room temperature) of at least 1·10⁵ S/m, such as at least 1·10⁶ S/m. Herein, a conductivity of an insulated material may especially be equal to or smaller than 1·10⁻¹⁰ S/m, especially equal to or smaller than 1·10⁻¹³ S/m. Herein a ratio of an electrical conductivity of an isolating material (insulator) and an electrical conductivity of an electrically conductive material (conductor) may especially be selected smaller than 1·10⁻¹⁵.

An electrically conductive contact may refer to a (physical) contact between two (or more) electrically conductive elements, such as between an electrically conductive track and an electrically conductive hub. When in such embodiments the electrical conductivity of the arrangement of the two conductive elements measured over the two conductive elements be at least 1·10⁶ S/m, then there is electrically conductive contact. It may also refer in specific embodiments to an arrangement of two (or more) electrically conductive elements with a medium in between. When in such embodiments the electrical conductivity of the arrangement of the two conductive elements measured over the two conductive elements with the medium in between, be at least 1·10⁶ S/m, then there is also electrically conductive contact.

In embodiments, the PCB may comprise one or more electrically conductive elements. Especially, such electrically conductive element may comprise a layer element.

The term “electrically conductive track” may be used to referrer to such an electrically conductive layer element. An electrically conductive track may comprise a metal layer. For instance, in embodiments the metal layer may be an aluminum layer. Instead of (or in addition to) aluminum, the metal layer may comprise a copper layer. For instance, in embodiments the metal layer may be a copper layer. Other solutions may also be possible, like stainless steel, other metals, or (their) metal alloys. Especially, the electrically conductive track may comprise a metal core of the PCB. Especially, the electrically conductive track may be available over essentially the entire PCB. In embodiments, the term “electrically conductive element” may especially refer to an electrically conductive track.

In embodiments, an external electricity source may provide a (constant) electric current to electrically conductive elements of the light chamber via electrically conductive wires that may be inserted into electrically conductive connector units. Such connector units may facilitate the delivery of a constant electric current to the PCB and the electrical components that are comprised by the light chamber. Especially, such connector units may be placed on the same electrically conductive copper layer comprised by an electrically conductive track on a PCB and deliver the constant electric current through the electrically conductive track.

Hence, the first electrically conductive track may facilitate delivery of the constant electric current from the external electricity source to the light chamber. Especially, it may facilitate delivery of a constant electric current to the (plurality of) light source. Further, it may provide a support function and may have a thermal dissipation function and/or a thermal spread function.

In embodiments, the plurality of light sources may extend from the light source support. As such they may be defined as having a light source height (H1) relative to the light source support. Further, the one or more support elements may have a support element height (H2). The support element height H2 may be relative to the light source support in those embodiments where the support elements are placed on the light source support. In other embodiments, the light source support may instead (or additionally) be placed on top the light chamber support, and the support element H2 may then be defined relative to the light chamber support in those embodiments. In all such embodiments, H2>H1. Hence, any pressure on the light transmissive window may be compensated for by the support elements and may not present a safety hazard for the plurality of light sources.

In specific embodiments, at least one of the one or more support elements may be at least partly ring-shaped. In further embodiments, the one or more support elements may comprise other shapes. For instance, the support element shape may be cylindrical, cuboid, polygonal prismatic, etc. In other embodiments, the support elements may be configured in shapes with parallel alignment. The shapes may then especially be a line or square and form a grid-like pattern. For instance, the support elements form a grid. As the light sources may also form a grid, there may be a 2D grid of repeating elements, wherein each element comprises one or more support elements and one or more light sources.

In certain embodiments, the one or more support elements may comprise through-holes to allow other materials, such as a light chamber fluid or coolant channel, to pass through the at least partly ring-shaped support element.

One or more light sources of the plurality of light sources may be configured at one side of such support element. One or more of other light sources of the plurality of light sources may be configured at another side of such support element. Hence, the support element positioning may be optimized to support the light transmissive window without hindering the light source light from reaching the reactor chamber.

In such embodiments, the one or more support elements may comprise a plurality of support elements. Further, support elements may be configured in concentric circles. Hence, the support elements may provide support for the light transmissive window in concentric circles, which may be especially optimized for embodiments in which the light chamber and/or the reactor chamber have a round shape. In embodiments, the one or more support elements may be one or more of transmissive and reflective for the light source light. In such embodiments, where the support elements are transmissive for light source light, any light source light escaping in the direction of the support elements may be transmitted through the support element. Hence, at least part of the light source light escaping in the direction of the support elements may eventually escape the light chamber into the reactor chamber. In such embodiments where the support elements may be reflective for light source light, any light source light escaping in the direction of the light source support may hence be reflected back to the direction of the reactor chamber, which may be more efficient.

In embodiments, the reaction chamber pressure compensating system may also comprise a second fluid. Especially, in embodiments the light chamber may further comprise a second fluid (or: “light chamber fluid”). Such a second fluid may provide an additional measure to compensate for the increased reactor chamber pressure P_{R}. Especially in such embodiments without a reactor chamber pressure sensor, the second fluid may provide additional support to materials in the light chamber to ensure safe operation of the (photo)chemical reactor. Hence, any pressure on the light transmissive window may be compensated for by second fluid and may not present a safety hazard for the plurality of light sources.

Certain embodiments may use both a second fluid and support elements for a particularly robust compensation for the increased reactor chamber pressure P_{R}.

The second fluid may be configured in the light chamber. In embodiments, the light chamber fluid may fill the entire light chamber such that essentially no (other) gas is left in the light chamber. In other embodiments, the light chamber fluid may fill up a section of the light chamber adjacent to the transmissive window. The light chamber fluid may be transmissive for the light source radiation such that it may reach the reactor chamber. The light chamber fluid may have the light chamber pressure P_{L} and may allow it to be more evenly distributed, hence preventing single pressure points where failure or breakage could occur.

Especially, at pressures of at least 1 bar, the second fluid fills essentially all empty space in the light chamber. The second fluid may comprise comprises one or more of a mineral oil, a silicone oil, waterglass, silicon gel, air, nitrogen, neon gas, argon gas, or other inert gasses. Such oils and/or gasses may be selected based on their ability to (i) facilitate proper functioning of the light chamber components, and (ii) support the light chamber components against reactor chamber pressure P_{R}. Further considerations may involve costs and availability. Especially, the second fluid is not electrically conductive. Hence, essentially, the second fluid may be electrically insulating. An electrically conductive element may comprise, or essentially consist of electrically conductive material. An electrically insulating element may comprise, or essentially consist of electrically insulating material. Herein, in embodiments a conductive material may especially comprise a conductivity (at room temperature) of at least 1·10⁵ S/m, such as at least 1·10⁶ S/m. Herein, a conductivity of an insulated material may especially be equal to or smaller than 1·10⁻¹⁰ S/m, especially equal to or smaller than 1·10⁻¹³ S/m. Herein a ratio of an electrical conductivity of an isolating material (insulator) and an electrical conductivity of an electrically conductive material (conductor) may especially be selected smaller than 1·10⁻¹⁵.

In embodiments, the pressure control system may be configured to control a pressure difference ΔP between the light chamber pressure P_{L} and the reactor chamber pressure P_{R}. When the pressure difference ΔP increases it may result in failure or breakage of the photochemical reactor. Hence, the pressure control system may be configured to maintain the pressure difference ΔP. The pressure difference ΔP may be kept to below 0.5*P_{R}, such as below 0.4*P_{R}. Further, the pressure difference ΔP may be kept to below 0.3*P_{R}, such as below 0.2*P_{R}. In embodiments, the pressure difference ΔP may be kept to below 0.15*P_{R}, especially below 0.1*P_{R}. Further, the pressure difference ΔP may be kept to below 0.08*P_{R}, such as below 0.06*P_{R}. Moreover, the pressure difference ΔP may be kept to below 0.04*P_{R}, such as below 0.02*P_{R}. In embodiments, especially at relatively high pressures in the reactor chamber, the pressure difference may be relatively lowest, like below 0.01*P_{R}, or even below 0.0001*P_{R}.

The control system may be able to calculate the pressure difference ΔP using feedback from a reactor chamber pressure sensor and a light chamber pressure sensor. In such embodiments, the control system may be able to control the light chamber pressure P_{L} in response to increases in the pressure difference ΔP. In other embodiments, the pressure difference ΔP may be approximated by the control system based on feedback from a reactor chamber pressure sensor, wherein the control system may approximate the pressure difference ΔP by considering the light chamber pressure P_{L} as atmospheric pressure. In other embodiments, the pressure difference ΔP may be approximated by the control system based on the rotational speed of the spinning disk reactor. In such embodiments, the reactor chamber pressure P_{R} and light chamber pressure P_{L} may be known under standard operation of the spinning disk reactor at varying rotational speeds, such that the pressure difference ΔP can safely be approximated based on the rotational speed of the spinning disk reactor. In certain embodiments, the control system may operate on a feedforward system wherein early signs of increased pressure difference ΔP may lead to controlling the light chamber pressure P_{L} to compensate.

In certain embodiments, the photoreactor assembly may calculate and/or approximate the pressure difference ΔP. In such embodiments, once pressure difference ΔP reaches a threshold (or: “safety threshold”), the control system may shut down operation of the light source. Hence the operation of the photoreactor assembly may be controlled depending on the pressure difference ΔP remaining below the safety threshold.

Such safety threshold may be at least 0.15*P_{R}, such as 0.2*P_{R}, or especially 0.25*P_{R}. In further embodiments, the safety threshold may be at least 0.3*P_{R}, such as 0.4*P_{R}, or especially 0.5*P_{R}.

The photochemical assembly may further comprise a pressure equalizer (or: “equalizer”). Such a pressure equalizer may provide an additional measure to compensate for the increased reactor chamber pressure P_{R} by equalizing P_{L} to P_{R}. Especially in such embodiments without a reactor chamber pressure sensor, the pressure equalizer may a mechanism to keep the ΔP sufficiently low to ensure safe operation of the (photo)chemical reactor. Hence, any pressure on the light transmissive window from the reactor chamber pressure P_{R} may be compensated for the pressure equalizer ensuring increased light chamber pressure P_{L}.

In embodiments, the pressure equalizer may be comprise a channel connecting the light chamber and the reactor chamber. Especially, such channel may comprise a membrane that allows fluid exchange and may ensure that: (i) the first fluid does not enter into the light chamber, and (ii) the pressure equalizes between the light chamber and the reactor chamber. In other embodiments, the pressure equalizer may comprise a pressure control valve. Such membrane may also be indicated as pressure control membrane.

Certain embodiments may use a second fluid, a support element, and a pressure equalizer for a particularly robust compensation for the increased reactor chamber pressure P_{R}. Other embodiments may use a second fluid and a pressure equalizer or a support element and a pressure equalizer to achieve safe operation.

In embodiments, the reaction chamber pressure compensating system may be comprise at least one or more elements that serve to compensate for the increased reaction chamber pressure P_{R} (in relation to the light chamber pressure P_{L} and the stability of the light transmissive window. Especially, the reaction chamber pressure compensating system may serve to support the light transmissive window. Hence, the reaction chamber pressure compensating system may ensure safe operation of the photochemical assembly when the increased reaction chamber pressure P_{R} might potentially cause breakage of the light transmissive window, would such reaction chamber pressure compensating system not be available.

Such elements of the reaction chamber pressure compensating system may comprise (i) a pressure equalizer, (ii) a second fluid, (iii) one or more support elements, and (iv) a pressure control system. Certain embodiments may use at least one or more of these elements as this may be sufficient to achieve safe operation of the photochemical reactor. Further embodiments may use at least two or more of these elements, especially at least three or more of these elements, which may provide improved safety during operation and provides additional safeguards should one element not be sufficient to compensate for the increased reaction chamber pressure P_{R}. Especially, embodiments may use three (or optionally all four) of these elements for a particularly robust compensation for the increased reactor chamber pressure P_{R}. In embodiments, one may choose between the pressure equalizer and pressure control system, and optionally also choose one or more of the second fluid and the support elements.

In embodiments, the pressure control system may be used to control the light chamber pressure P_{L} in response to an increase in the reaction chamber pressure P_{R}. The pressure control system may especially comprise a control system that may one or more of (i) measure, (ii) calculate, or (iii) approximate the pressure difference Δ_{P} between the light chamber pressure P_{L} and the reactor chamber pressure P_{R}, and measure, calculate, or approximate the pressure the reactor chamber pressure P_{R}. On the basis thereon, the pressure in the light chamber may be adapted (and/or optionally the pressure in the reaction chamber), whereby the pressure difference can be reduced or maintained with a predefined difference range (see also above in relation to Δ_{P}).

The control system may further control the light chamber pressure P_{L} in response to changes in the pressure difference Δ_{P}. In certain embodiments, the control system may further be able to control the reaction chamber pressure P_{R} in response to changes in the pressure difference Δ_{P}. Specifically, the control system may control other aspects of the photoreactor assembly, e.g. a radiant flux of the light source (radiation), temperature of the first fluid, composition of the first fluid.

Herein, controlling the controlling the light source radiation may refer to controlling one or more of radiation flux and spectral power distribution, especially at least the radiation flux.

Hence, in embodiments, a radiant flux of the light source radiation may be controllable. This may be adjusted depending on the (photo)chemical reaction taking place. It may also be adjusted depending on the rotational speed of the spinning disk. Hence, the radiant flux of the light source radiation may be optimized to the (photo)chemical reaction.

The control system may be configured to control the light chamber pressure P_{L} in dependence of the radiant flux of the light source radiation. This may especially be the case in embodiments where the rotational speed of the spinning disk may be linked to the (photo)chemical reaction. Hence, the radiant flux of the light source radiation may be optimized for the (photo)chemical reaction while the light chamber pressure P_{L} is adjusted to compensate appropriately for the reactor chamber pressure P_{R}. The control system may be configured to control the reactor chamber pressure P_{R} in dependence of the radiant flux of the light source radiation. In such embodiments, P_{R} may be controllable. Thereby the control system may be able to directly control the reactor chamber P_{R} to the radiant flux of the light source light to be optimized for the (photo)chemical reaction.

Further, a spectral power distribution of the light source radiation may be controllable. The (photo)chemical reaction may in embodiments be especially activated by light source light of a specific wavelength. Other (photo)chemical reactions performed in the same photoreactor assembly may be activated by light source light of another wavelength.

Hence, the spectral power distribution of the light source radiation may be adjusted so that it may optimize for different (photo)chemical reaction rates. Especially, the control system may be configured to control the spectral power distribution of the light source radiation.

In certain embodiments, the (photo)chemical reaction may comprise a multi-step process of at least two or more (photo)chemical reactions. In some, different reactions may be activated by light source light at different wavelengths. Adjusting the spectral power distribution of the light source light during operation may hence drive different (photo)chemical reactions.

The photoreactor assembly may comprise a plurality of light source arrangements. In such embodiments, the photochemical reactor may comprise (i) a plurality of reactor chambers, functionally coupled to each other, and (ii) a plurality of spinning disks. The photoreactor assembly may hence comprise a plurality of units. Each unit may comprise one or more of the light chambers, one or more of the reactor chambers, and one or more of the spinning disks partly configured in the reaction chamber. Such embodiments may facilitate performing different (photo)chemical reactions simultaneously, or performing the same (photo)chemical reaction in large quantities in multiple units. In further embodiments, the photoreactor assembly may further comprise a fluidic system comprising one or more reactor channels connecting the plurality of reactor chambers. In such embodiments, the fluid system may facilitate a multi-step (photo)chemical reaction taking place in different reactor channels.

In such embodiments, the control system may be configured to individually control the spectral power distribution of the light source light of the respective light source arrangements of the plurality of units. In such embodiments, the multi-step (photo)chemical reaction may be exposed to light source light with different spectral power distribution. Hence, different (photo)chemical reaction steps may be exposed to optimized (photo)chemical conditions.

In specific embodiments, the photochemical reactor may be a microflow reactor. Especially, the first fluid may be a gas. Further, the light source arrangement may have a light source length L1 from the light source support to the transmissive material. The photochemical reactor may have a reactor length L2 parallel from the transmissive material to a parallel reactor side. In such embodiments, L1≤1 mm and L2≤1 mm. In further such embodiments, the spinning disk may have a spinning disk diameter øl up to a maximum of 60 cm. Such spinning disk may generate up to 50 bar reactor chamber pressure P_{R}. Further, the light source arrangement may have a circular shape. The light source arrangement may have a light source diameter ø2 up to a maximum of 60 cm. In such embodiments, 1.2≥ø1/ø2≥0.8.

In a further aspect, the invention may provide a method for treating a first fluid with light source radiation. In embodiments, the method may comprise providing the first fluid to be treated with light source radiation in embodiments of the photochemical reactor of the photoreactor assembly described above. Further, the method may comprise irradiating the first fluid with the light source radiation.

Moreover, in embodiments the method may comprise controlling the light chamber pressure P_{L} in the light chamber.

In such embodiments, the method may comprise transporting the first fluid through the photochemical reactor. Especially, the first fluid may be irradiated with the light source radiation. Further, one or more of the light source radiation of the plurality of light sources may be controlled. A rotational speed of the spinning disk may also be controlled.

In further embodiments of the method, the control system may be configured to control a pressure difference Δ_{P} between the light chamber pressure P_{L} and the reactor chamber pressure P_{R}. In embodiments, the control system may be configured to maintain the pressure difference Δ_{P} below |+/−0.2*P_{R}|. Especially, the control system may be configured to maintain the pressure difference Δ_{P} below |+/−0.1*P_{R}|. The photoreactor assembly may further comprise a at least one or more support elements, a second fluid, and/or a pressure equalizer configured to equalize the light source pressure P_{L} to the reactor chamber pressure P_{R}.

Further, a radiant flux of the light source radiation may be controllable during the method. The control system may be configured to control the light chamber pressure P_{L} in dependence of the radiant flux of the light source radiation. The control system may further be configured to control the reactor chamber pressure P_{R} in dependence of the radiant flux of the light source radiation. Moreover, a spectral power distribution of the light source radiation may be controllable. Especially, the control system may be configured to control the spectral power distribution of the light source radiation.

In further embodiments, the method may comprise providing the fluid to be irradiated to the photoreactor assembly comprising a plurality of light source arrangements as described above. In such embodiments, the photoreactor assembly may comprise a fluidic system comprising one or more reactor channels connecting the plurality of reactor chambers through which the fluid may be provided.

In further embodiments, the photoreactor assembly may comprise one or more light source arrangements; wherein the photochemical reactor comprises and one or more reaction chambers (which may be functionally coupled to each other when there are a plurality of reaction chambers), wherein the photoreactor assembly comprises one or more of units, wherein each unit comprises one of the one or more light chambers and one of the one or more reactor chambers.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIGS. 1A-C schematically depicts embodiments of a photoreactor assembly;

FIGS. 2A-C schematically depicts further embodiments of a photoreactor assembly;

FIG. 3 schematically depicts some embodiments; and

FIG. 4 schematically depicts yet a further embodiment of a photoreactor assembly.

The schematic drawings are not necessarily to scale.

### DETAILED DESCRIPTION OF THE EMBODIMENTS

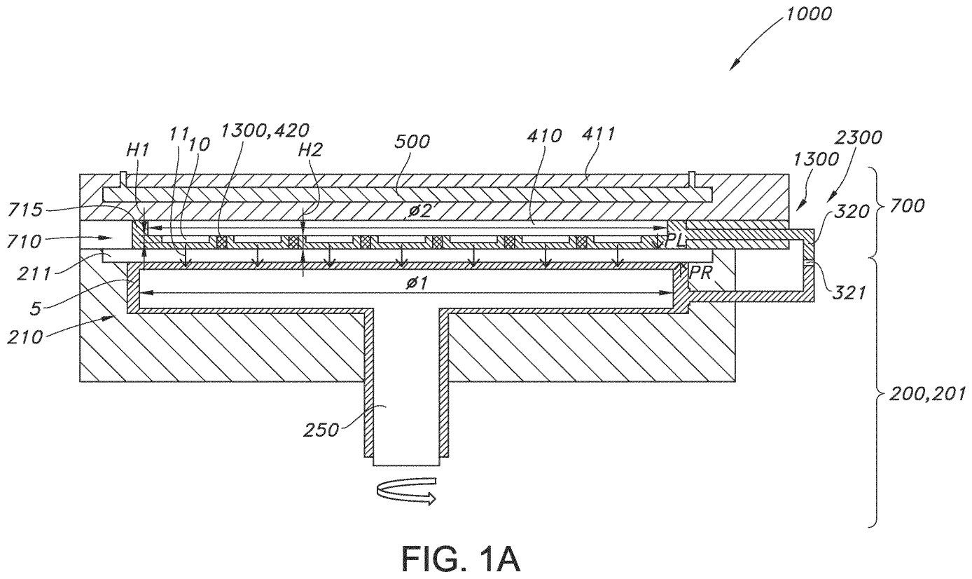

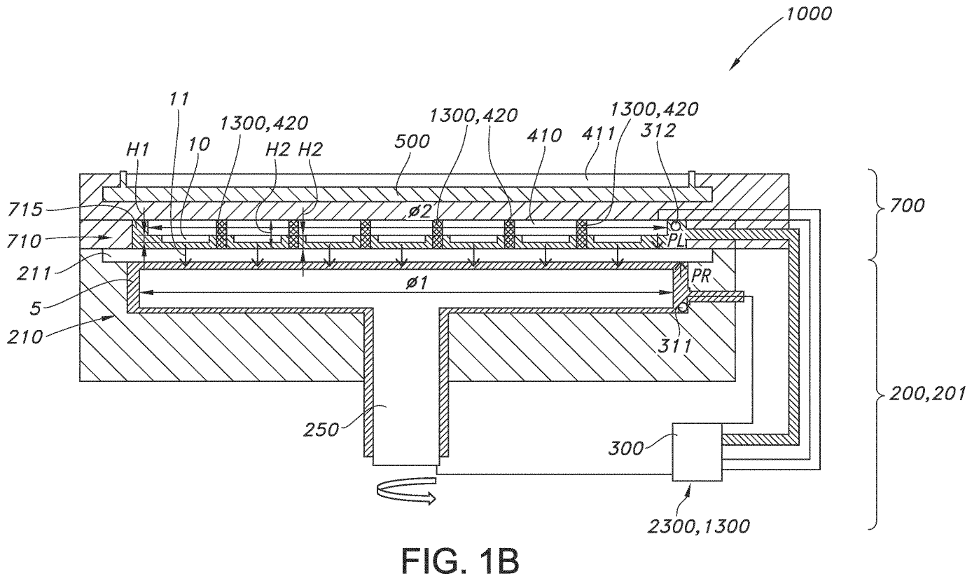

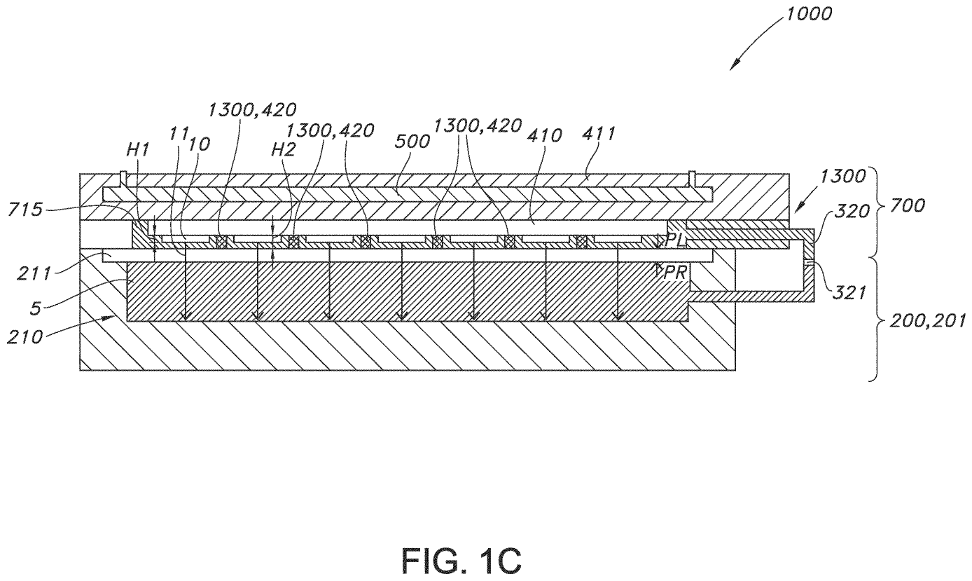

FIGS. 1A-B schematically depicts a photoreactor assembly 1000 comprising (i) a light source arrangement 700, (ii) a photochemical reactor 200, and (iii) a reaction chamber pressure compensation system 1300. In such embodiments, the light source arrangement 700 comprises a light chamber 710 hosting a plurality of light sources 10. The light sources 10 are configured to generate light source radiation 11 selected from one or more of UV radiation, visible radiation, and IR radiation. Further, the light chamber 710 has a light chamber pressure P_{L}. In embodiments, the photochemical reactor 200 comprises a reactor chamber 210 configured to host a first fluid 5 to be treated with the light source radiation 11. The photochemical reactor 200 comprises a light transmissive window 211 that is transmissive for the light source radiation 11. The light transmissive window 211 separates the light chamber 710 from the reactor chamber 210. Further, the plurality of light sources 10 are configured to irradiate at least part of the reactor chamber 210 via the light transmissive window 211. In embodiments, the photochemical reactor 200 comprises a spinning disk reactor 201. The spinning disk reactor 201 comprises a rotatable disk 250 at least partly configured in the reaction chamber 210. Especially, the reaction chamber pressure compensation system 1300 is configured to compensate for a reaction chamber pressure P_{R} in the reactor 200 on the light transmissive window 211.

In embodiments, the light sources 10 comprise solid state light sources. In further embodiments, the control system 300 is configured to control one or more of the light source radiation 11 of the plurality of light sources 10 and a rotational speed of the rotating disk 250.

The photoreactor assembly 1000 may in embodiments further comprising one or more support elements 420. The one or more support elements 420 are configured to support the light transmissive window 211. The one or more support elements 420 are in physical contact with the transmissive window 211. At least one of the support elements 4201 is configured between at least two light sources 10 of the plurality of light sources 10. The light transmissive window 211 comprises a light transmissive material selected from the group of quartz, sapphire, borosilicate glass, sodalime glass, mineral glass, laminated glass, coated glass.

The photoreactor assembly 1000 may further comprising a light source support 410 configured to support the plurality of light sources 10. In embodiments, the light source support may comprise a metal core PCB or a ceramic metal core PCB.

In embodiments, the one or more support elements 420 are one or more of transmissive and reflective for the light source light 11. In embodiments, the one or more support elements 420 comprise supporting studs.

In embodiments, the photoreactor assembly 1000 may further comprise a light chamber fluid 715 configured in the light chamber 710. The light chamber fluid 715 may be transmissive for the light source radiation 11. The light chamber fluid 715 may have the light chamber pressure P_{L}. In embodiments, the light chamber fluid 715 comprises one or more of a mineral oil, a silicone oil, silicone gel, air, nitrogen gas, neon gas, and argon gas.

In embodiments, the photoreactor assembly may further comprise a cooling channel 500.

The spinning disk 250 may have a diameter ø1 and the light chamber may have a diameter ø2. Note, however, that other shapes than circular are herein not excluded.

FIG. 1A schematically depicts an embodiment wherein further comprising a pressure equalizer 320 configured to equalize the light source pressure P_{L} to the reactor chamber pressure P_{R} by means of a pressure control membrane 321.

In embodiments, a radiant flux of the light source radiation 11 may be controllable. The control system 300 may be configured to control the light chamber pressure P_{L} in dependence of the radiant flux of the light source radiation 11.

In embodiments, reactor chamber pressure P_{R} may be controllable. The control system 300 may be configured to control the reactor chamber pressure P_{R} in dependence of the radiant flux of the light source radiation 11.

In embodiments, a spectral power distribution of the light source radiation 11 is controllable. The control system 300 is configured to control the spectral power distribution of the light source radiation 11.

In embodiments, the plurality of light sources 10 comprise one or more of chips-on-board light sources COB, light emitting diodes LEDs, laser diodes, and superluminescent diodes.

FIG. 1A schematically depict an embodiment wherein the plurality of light sources 10 extend from the light source support 410 and have a light source height H1 relative to the light source support 410. The one or more support elements 420 have a support element height H2. And especially, H2>H1. FIG. 1B depicts embodiments wherein the plurality of light sources 10 extend from the light chamber support 411 and have a light source height H1 relative to the light chamber support 411. The one or more support elements 420 have a support element height H2. And especially, H2>H1.

In embodiments, the control system 300 may be configured to control a pressure difference ΔP between the light chamber pressure P_{L} and the reactor chamber pressure P_{R}. The control system 300 may be configured to maintain the pressure difference ΔP below |+/−0.1*PR|.

FIG. 1C schematically depicts an embodiment wherein the photochemical reactor 200 is a flow channel reactor 202. Other embodiments, however, may also be possible, such as in the case of a spinning disk reactor, wherein the reactor chamber may have cross-sectional dimensions different from an upstream channel (part) and/or a downstream channel (part).

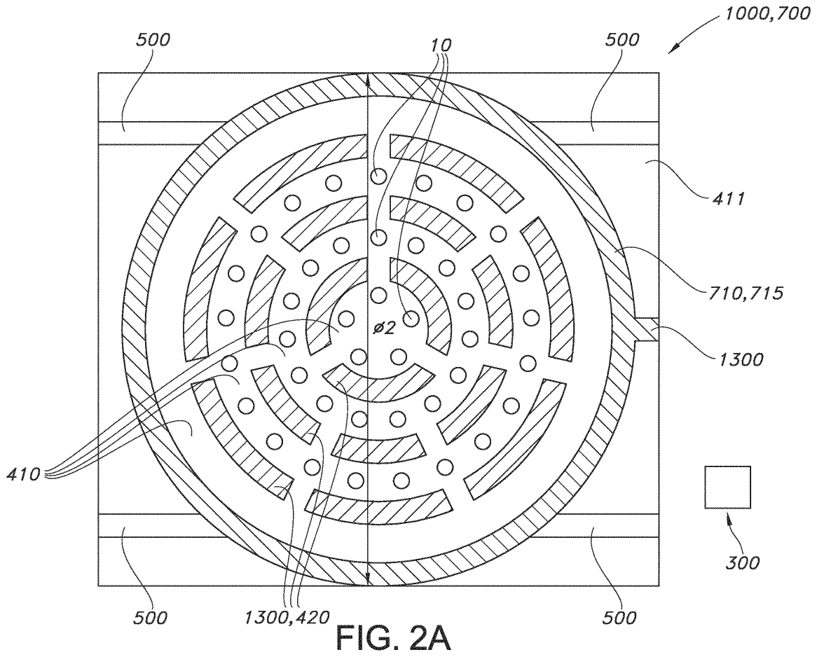

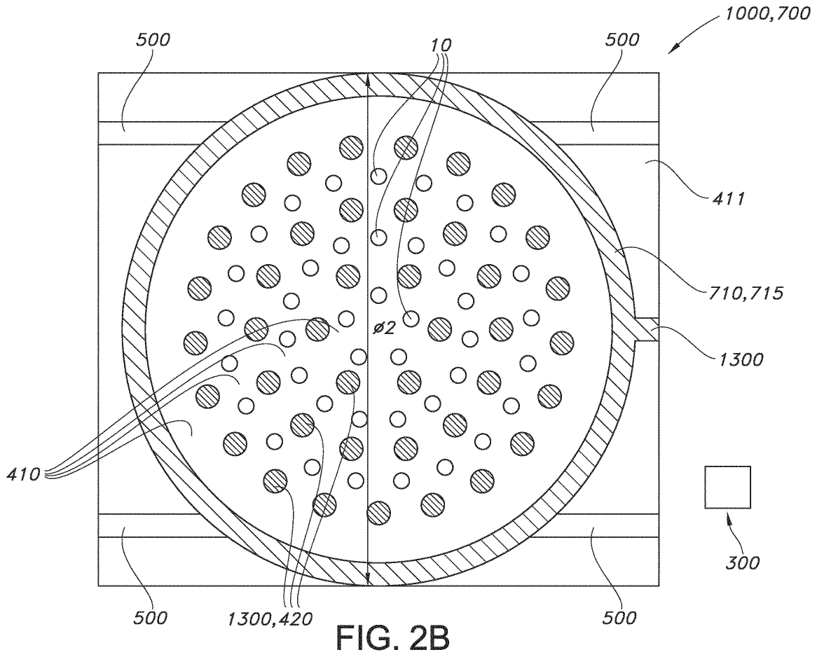

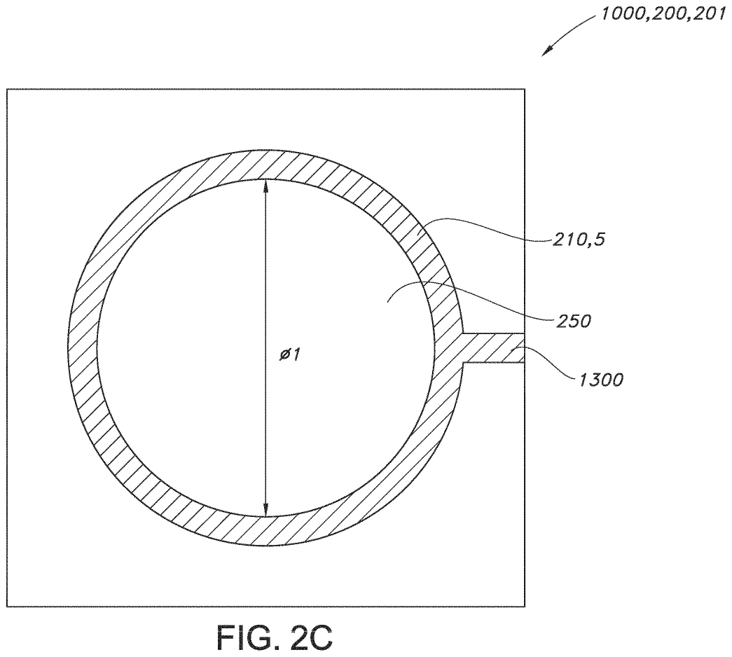

FIG. 2A-B depicts embodiments at least one of the one or more support elements 420 is at least partly ring-shaped (2A) or have another shape (2B). One or more light sources 10 of the plurality of light sources 10 are configured at one side of the at least partly ring-shaped support element 420. One or more other light sources 10 of the plurality of light sources 10 are configured at another side of the at least partly ring-shaped support element 420. In embodiments, the photoreactor assembly 1000 may comprise a plurality of at least partly ring-shaped support elements 420, configured in concentric circles.

FIG. 2B schematically depicts embodiments wherein the support elements 420 are cylindrical studs. At least one of the support elements 420 is configured between at least two light sources 10 of the plurality of light sources 10. In further embodiments, the photoreactor assembly 1000 may comprise a plurality of support elements 420 that may have a circular, square, rectangular, hexagonal, or other shape.

FIG. 2C schematically depicts a cross-sectional view of a reactor chamber 210 comprising a rotatable disk 250.

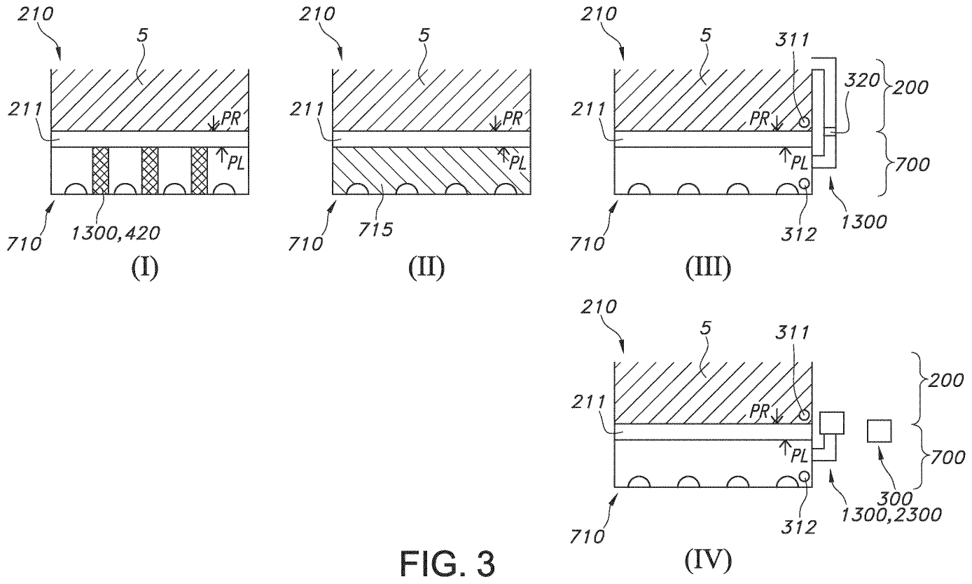

FIG. 3C schematically depicts a number of options that may be comprised by the reaction chamber pressure compensation system 1300. Embodiment I schematically depicts a photoreactor assembly 1000 comprising support elements 420 to compensate for the reactor chamber pressure P_{R}. Embodiment II schematically depicts a photoreactor assembly 1000 comprising a second fluid 715 in the light chamber 700 to compensate for the reactor chamber pressure P_{R}. Embodiment III schematically depicts a photoreactor assembly 1000 comprising a pressure equalizer 320 to compensate for the reactor chamber pressure P_{R}. Embodiment IV schematically depicts a photoreactor assembly 1000 comprising a pressure control system 2300, wherein a control system 300 uses a reactor chamber pressure sensor 311 and a light chamber pressure sensor 312 to calculate the pressure difference ΔP and compensate for the reactor chamber pressure P_{R}.

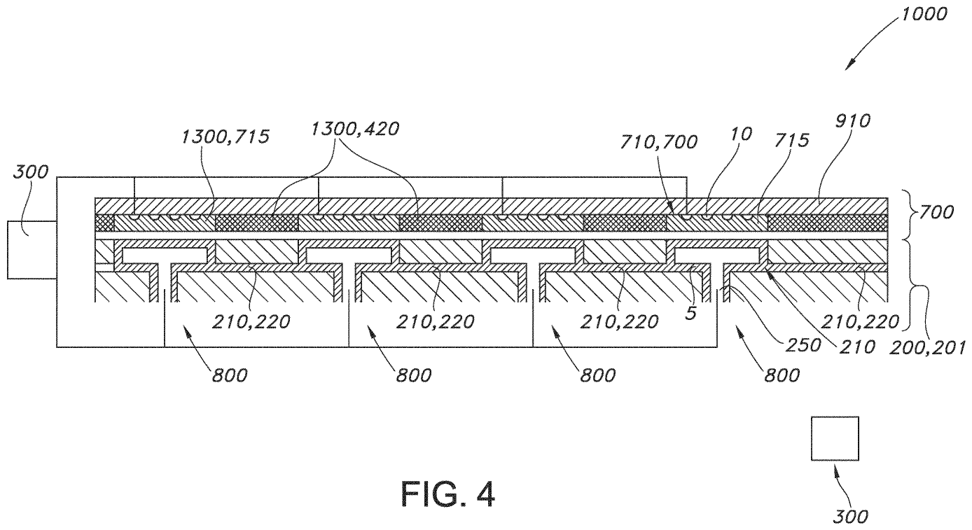

FIG. 4 depicts embodiments wherein the photoreactor assembly 1000 comprises a plurality of light source arrangements 700. The photochemical reactor 200 comprises (i) a plurality of reactor chambers 210, functionally coupled to each other, and (ii) a plurality of rotatable disks 250. Further, the photoreactor assembly 1000 comprises a plurality of units 800. Each unit 800 comprises one of the light chambers 710, one of the reactor chambers 210, and one of the rotatable disks 250 partly configured in the reaction chamber 210. The photoreactor assembly 1000 may further comprises a fluidic system 210 comprising one or more reactor channels 220 connecting the plurality of reactor chambers 210. In embodiments, the control system 300 may be configured to individually control the spectral power distribution of the light source light 11 of the respective light source arrangements 700 of the plurality of units 800. Reference 910 indicates a support for the light sources.

The term “plurality” refers to two or more.

The terms “substantially” or “essentially” herein, and similar terms, will be understood by the person skilled in the art. The terms “substantially” or “essentially” may also include embodiments with “entirely”, “completely”, “all”, etc. Hence, in embodiments the adjective substantially or essentially may also be removed. Where applicable, the term “substantially” or the term “essentially” may also relate to 90% or higher, such as 95% or higher, especially 99% or higher, even more especially 99.5% or higher, including 100%.

The term “comprise” also includes embodiments wherein the term “comprises” means “consists of”.

The term “and/or” especially relates to one or more of the items mentioned before and after “and/or”. For instance, a phrase “item 1 and/or item 2” and similar phrases may relate to one or more of item 1 and item 2. The term “comprising” may in an embodiment refer to “consisting of” but may in another embodiment also refer to “containing at least the defined species and optionally one or more other species”.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

The devices, apparatus, or systems may herein amongst others be described during operation. As will be clear to the person skilled in the art, the invention is not limited to methods of operation, or devices, apparatus, or systems in operation.

It should be noted that the above-mentioned embodiments illustrate rather than limit the invention, and that those skilled in the art will be able to design many alternative embodiments without departing from the scope of the appended claims.

In the claims, any reference signs placed between parentheses shall not be construed as limiting the claim.

Use of the verb “to comprise” and its conjugations does not exclude the presence of elements or steps other than those stated in a claim. Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

The article “a” or “an” preceding an element does not exclude the presence of a plurality of such elements.

The invention may be implemented by means of hardware comprising several distinct elements, and by means of a suitably programmed computer. In a device claim, or an apparatus claim, or a system claim, enumerating several means, several of these means may be embodied by one and the same item of hardware. The mere fact that certain measures are recited in mutually different dependent claims does not indicate that a combination of these measures cannot be used to advantage. In yet a further aspect, the invention (thus) provides a software product, which, when running on a computer is capable of bringing about (one or more embodiments of) the method as described herein.

The invention also provides a control system that may control the device, apparatus, or system, or that may execute the herein described method or process. Yet further, the invention also provides a computer program product, when running on a computer which is functionally coupled to or comprised by the device, apparatus, or system, controls one or more controllable elements of such device, apparatus, or system.

The invention further applies to a device, apparatus, or system comprising one or more of the characterizing features described in the description and/or shown in the attached drawings. The invention further pertains to a method or process comprising one or more of the characterizing features described in the description and/or shown in the attached drawings.

The various aspects discussed in this patent can be combined in order to provide additional advantages. Further, the person skilled in the art will understand that embodiments can be combined, and that also more than two embodiments can be combined. Furthermore, some of the features can form the basis for one or more divisional applications.

1. A photoreactor assembly comprising (i) a light source arrangement, (ii) a photochemical reactor, and (iii) a reaction chamber pressure compensating system; wherein:
the light source arrangement comprises a light chamber hosting a plurality of light sources, wherein the light sources are configured to generate light source radiation selected from one or more of UV radiation, visible radiation, and IR radiation; wherein the light chamber has a light chamber pressure P_{L};
the photochemical reactor comprises a reactor chamber configured to host a first fluid to be treated with the light source radiation; wherein the photochemical reactor comprises a light transmissive window that is transmissive for the light source radiation; wherein the light transmissive window separates the light chamber from the reactor chamber; wherein the plurality of light sources are configured to irradiate at least part of the reactor chamber via the light transmissive window;
wherein the photochemical reactor comprises a spinning disk reactor, wherein the spinning disk reactor comprises a disk at least partly configured in the reaction chamber; and
the reaction chamber pressure compensating system is configured to compensate for a reactor chamber pressure P_{R} in the photochemical reactor on the light transmissive window; and
wherein the reaction chamber pressure compensating system comprises a pressure control system; wherein the photoreactor assembly further comprises a control system, wherein the control system is configured to control with the pressure control system a pressure difference Δ_{P} between the light chamber pressure P_{L} and the reactor chamber pressure P_{R}; wherein the control system is configured to maintain the pressure difference Δ_{P} below |+/−0.2*P_{R}|.

2. The photoreactor assembly according to claim 1, further comprising one or more support elements, wherein the one or more support elements are configured to support the light transmissive window, wherein at least one of the support elements is configured between at least two light sources of the plurality of light sources.

3. The photoreactor assembly according to claim 1, further comprising a light chamber fluid configured in the light chamber; wherein the light chamber fluid is transmissive for the light source radiation; wherein the light chamber fluid has the light chamber pressure P_{L}.

4. The photoreactor assembly according to claim 1, wherein the pressure control system comprises a pressure equalizer configured to equalize the light source pressure P_{L} to the reactor chamber pressure P_{R}.

5. The photoreactor assembly according to claim 1, wherein the light sources comprise solid state light sources, wherein the light transmissive window comprises a light transmissive material selected from the group of quartz, sapphire, borosilicate glass, sodalime glass, mineral glass, laminated glass, coated glass; wherein the photoreactor assembly further comprises a light source support configured to support the plurality of light sources; and wherein the light source support comprises a metal core PCB or a ceramic metal core PCB.

6. The photoreactor assembly according to claim 5; wherein the plurality of light sources extend from the light source support and have a light source height relative to the light source support; wherein the one or more support elements have a support element height, and wherein H2>H1; and wherein the one or more support elements are transmissive for the light source light.

7. The photoreactor assembly according to claim 1, wherein a radiant flux of the light source radiation is controllable, and wherein the control system is configured to control the light chamber pressure P_{L} in dependence of the radiant flux of the light source radiation.

8. The photoreactor assembly according to claim 1, wherein the control system is configured to reduce a radiant flux of the light sources when the pressure difference Δ_{P} reaches above |+/−0.2*P_{R}|.

9. The photoreactor assembly according to claim 2, comprising a 2D array of light sources and a 2D array of support elements, wherein the support elements have shapes selected from cylindrical, cuboid, and polygonal prismatic.

10. The photoreactor assembly according to claim 3, wherein the light chamber fluid comprises one or more of a mineral oil, a silicone oil, silicon gel, air, nitrogen gas, neon gas, and argon gas.

11. The photoreactor assembly according to claim 1; wherein the photoreactor assembly comprises a plurality of light source arrangements; wherein the photochemical reactor comprises (i) a plurality of reactor chambers, functionally coupled to each other, and (ii) a plurality of disks; wherein the photoreactor assembly comprises a plurality of units, wherein each unit comprises one of the light chambers, one of the reactor chambers, and one of the disks partly configured in the reaction chamber.

12. The photoreactor assembly according to claim 1, wherein the control system is configured to individually control the spectral power distribution of the light source light of the respective light source arrangements of the plurality of units.

13. A method for treating a first fluid with light source radiation, wherein the method comprises:
providing the first fluid to be treated with the light source radiation in the photochemical reactor of the photoreactor assembly;
and irradiating the first fluid with the light source radiation.

14. The method according to claim 13, further comprising:
controlling the light chamber pressure P_{L} in the light chamber; and
transporting the first fluid through the photochemical reactor while irradiating the first fluid with the light source radiation and controlling one or more of the light source radiation of the plurality of light sources and a rotational speed of the spinning disk.
